(19) United States
(12) Patent Application Publication
(10) Pub. No.: US 2019/0138095 A1
(43) Pub. Date: May 9, 2019

(54) DESCRIPTIVE TEXT-BASED INPUT BASED ON NON-AUDIBLE SENSOR DATA

(71) Applicant: QUALCOMM Incorporated, San Diego, CA (US)

(72) Inventors: Erik Visser, San Diego, CA (US); Sunkuk Moon, San Diego, CA (US); Yinyi Guo, San Diego, CA (US); Lae-Hoon Kim, San Diego, CA (US); Shuhua Zhang, San Diego, CA (US)

(21) Appl. No.: 15/803,031

(22) Filed: Nov. 3, 2017

(51) Int. Cl. G06F 3/01; G10L 15/24; G08B 21/04

(52) U.S. Cl. CPC G06F 3/015; G06F 3/013; G08B 21/0453; G08B 21/0446; G10L 15/24

(57) ABSTRACT

An apparatus includes one or more sensor units configured to detect non-audible sensor data associated with a user. The apparatus also includes a processor, including an action determination unit, coupled to the one or more sensors units. The processor is configured to generate a descriptive text-based input based on the non-audible sensor data. The processor is also configured to determine an action to be performed based on the descriptive text-based input.

### I. FIELD

The present disclosure is generally related to sensor data detection.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Some electronic devices include voice assistants that enable natural language processing. For example, the voice assistants may enable a microphone to capture a vocal command of a user, process the captured vocal command, and perform an action based on the vocal command. However, voice assistants may not be able to provide adequate support to the user solely based on the vocal command.

### III. SUMMARY

According to a particular implementation of the techniques disclosed herein, an apparatus includes one or more sensor units configured to detect non-audible sensor data associated with a user. The apparatus also includes a processor, including an action determination unit, coupled to the one or more sensors units. The processor is configured to generate a descriptive text-based input based on the non-audible sensor data. The processor is also configured to determine an action to be performed based on the descriptive text-based input.

According to another particular implementation of the techniques disclosed herein, a method includes detecting, at one or more sensor units, non-audible sensor data associated with a user. The method also includes generating, at a processor, a descriptive text-based input based on the non-audible sensor data. The method further includes determining an action to be performed based on the descriptive text-based input.

According to another particular implementation of the techniques disclosed herein, a non-transitory computer-readable medium includes instructions that, when executed by a processor, cause the processor to perform operations including processing non-audible sensor data associated with a user. The non-audible sensor data is detected by one or more sensor units. The operations also include generating a descriptive text-based input based on the non-audible sensor data. The operations further include determining an action to be performed based on the descriptive text-based input.

According to another particular implementation of the techniques disclosed herein, an apparatus includes means for detecting non-audible sensor data associated with a user. The apparatus further includes means for generating a descriptive text-based input based on the non-audible sensor data. The method also includes means for determining an action to be performed based on the descriptive text-based input.

Other implementations, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a system that is operable to perform an action based on sensor analysis;

FIG. 2 is another system that is operable to perform an action based on sensor analysis;

FIG. 3 is a system that is operable to perform an action based on multi-sensor analysis;

FIG. 4 is a process diagram for performing an action based on multi-sensor analysis;

FIG. 5 is another process diagram for performing an action based on multi-sensor analysis;

FIG. 6 is another process diagram for performing an action based on multi-sensor analysis;

FIG. 7 is a diagram of a home;

FIG. 8 is another process diagram for performing an action based on multi-sensor analysis;

FIG. 9 is an example of performing an action;

FIG. 10 is a method of performing an action based on sensor analysis;

FIG. 11 is another method of performing an action based on sensor analysis; and

FIG. 12 is a block diagram of a particular illustrative example of a mobile device that is operable to perform the techniques described with reference to FIGS. 1-11.

### V. DETAILED DESCRIPTION

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

In the present disclosure, terms such as “determining”, “calculating”, “estimating”, “shifting”, “adjusting”, etc. may be used to describe how one or more operations are performed. It should be noted that such terms are not to be construed as limiting and other techniques may be utilized to perform similar operations. Additionally, as referred to herein, “generating”, “calculating”, “estimating”, “using”, “selecting”, “accessing”, and “determining” may be used interchangeably. For example, “generating”, “calculating”, “estimating”, or “determining” a parameter (or a signal) may refer to actively generating, estimating, calculating, or determining the parameter (or the signal) or may refer to using, selecting, or accessing the parameter (or signal) that is already generated, such as by another component or device.

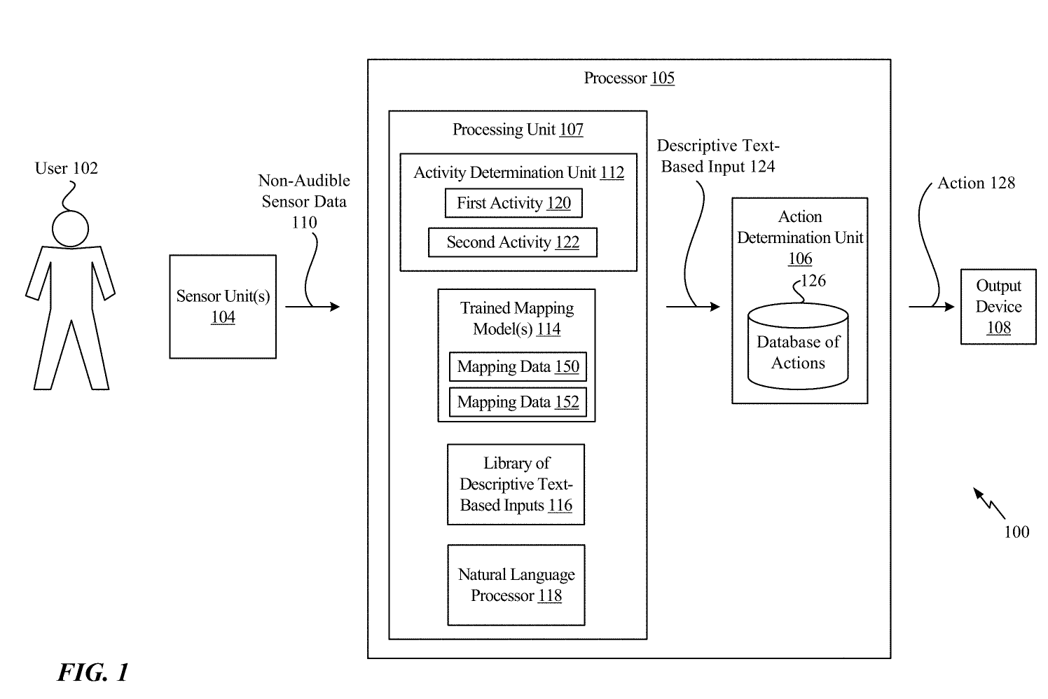

Referring to FIG. 1, a system 100 that is operable to perform an action based on sensor analysis is shown. The system 100 includes one or more sensor units 104, a processor 105, and an output device 108. According to one implementation, the one or more sensor units 104 are coupled to the processor 105, and the processor 105 is coupled to the output device 108. The processor 105 includes an activation determination unit 106 and a processing unit 107. According to some implementations, the system 100 may be integrated into a wearable device. For example, the system 100 may be integrated into a smart watch worn by a user 102, a headset worn by the user 102, etc. According to other implementations, the system 100 may be integrated into a mobile device associated with the user 102. For example, the system 100 may be integrated into a mobile phone of the user 102.

The one or more sensor units 104 are configured to detect non-audible sensor data 110 associated with the user 102. According to one implementation, the non-audible sensor data 110 may be physiological data (associated with the user 102) that is detected by the one or more sensor units 104. The physiological data may include at least one of electroencephalogram data, electromyogram data, heart rate data, skin conductance data, oxygen level data, glucose level data, etc.

The processing unit 107 includes an activity determination unit 112, one or more trained mapping models 114, a library of descriptive text-based inputs 116, and a natural language processor 118. Although the components 112, 114, 116, 118 are included in the processing unit 107, in other implementations, the components 112, 114, 116, 118 may be external to the processing unit 107. For example, one or more of the components 112, 114, 116, 118 may be included in a processor external to the processing unit 107. The processing unit 107 may be configured to generate a descriptive text-based input 124 based on the non-audible sensor data 110. As used herein, the descriptive text-based input 124 may include one or more words that associate a contextual meaning to one or more numerical values, and the one or more numerical values may be indicative of the non-audible sensor data 110.

To illustrate, the activity determination unit 112 is configured to determine an activity in which the user 102 is engaged. As a non-limiting example, the activity determination unit 112 may determine whether the user 102 is engaged in a first activity 120 or a second activity 122. According to one implementation, the activity determination unit 112 may determine the activity in which the user 102 is engaged based on a time of day. As a non-limiting example, the activity determination unit 112 may determine that the user 102 is engaged in the first activity 120 (e.g., resting) if the time is between 11:00 am and 12:00 pm, and the activity determination unit 112 may determine that the user 102 is engaged in the second activity 122 (e.g., running) if the time is between 12:00 pm and 1:00 pm. The determination may be based on historical activity data associated with the user 102. For example, the activity determination unit 112 may analyze historical activity data to determine that the user 102 usually engages in the first activity 120 around 11:15 am and usually engages in the second activity 122 around 12:45 pm.

The processing unit 107 may provide the non-audible sensor data 110 and an indication of the selected activity to the one or more trained mapping models 114. The one or more trained mapping models 114 is usable to map the non-audible sensor data 110 and the indication to mapping data associated with the descriptive text-based input 124. To illustrate using a non-limiting example, the non-audible sensor data 110 may include heart rate data that indicates a heart rate of the user 102, and the activity determination unit 112 may determine that the user 102 is engaged in the first activity 120 (e.g., resting). If the activity determination unit 112 determines that the user 102 is engaged in the first activity 120 (e.g., resting) and if the heart rate data indicates that the heart rate of the user 102 is within a first range (e.g., 55 beats per minute (BPM) to 95 BPM), the one or more trained mapping models 114 may map the non-audible sensor data 110 to mapping data 150. If the activity determination unit 112 determines that the user 102 is engaged in the first activity 120 and if the heart rate data indicates that the heart rate of the user 102 is within a second range (e.g., 96 BPM to 145 BPM), the one or more trained mapping models 114 may map the non-audible sensor data 110 to mapping data 152.

For ease of illustration, unless otherwise stated, the following description assumes that the one or more trained mapping models 114 maps the non-audible sensor data 110 to the mapping data 152. The mapping data 152 is provided to the library of descriptive text-based inputs 116. Each descriptive text-based input in the library of descriptive text-based inputs 116 is associated with different mapping data. The mapping data 152 is mapped to the descriptive text-based input 124 in the library of descriptive text-based inputs 116. As a non-limiting example, the descriptive text-based input 124 may indicate that the user 102 is “nervous”. According to some implementations, the descriptive text-based input 124 is provided to the natural language processor 118, and the natural language processor 118 transforms the text of the descriptive text-based input 124 to the user's 102 native (or preferred) language such that the descriptive text-based input 124 is intuitive to the user 102.

The action determination unit 106 is configured to determine an action 128 to be performed based on the descriptive text-based input 124. For example, the action determination unit 106 includes a database of actions 126. The action determination unit 106 maps the descriptive text-based input 124 (e.g., “nervous”) to the action 128 in the database of actions 126. According to the above example, the action 128 to be performed may include asking the user 102 whether he/she is okay. The output device 108 is configured to perform the action 128.

Thus, the system 100 of FIG. 1 enables physiological states of the user 102 to be considered in determining an action to be performed by a wearable device. In the scenario described above, the system 100 determines that heart rate of the user is substantially high (e.g., within the second range) while the user 102 is resting. As a result, the processing unit 107 generates the descriptive text-based input 124 to inquire whether the user 102 is okay.

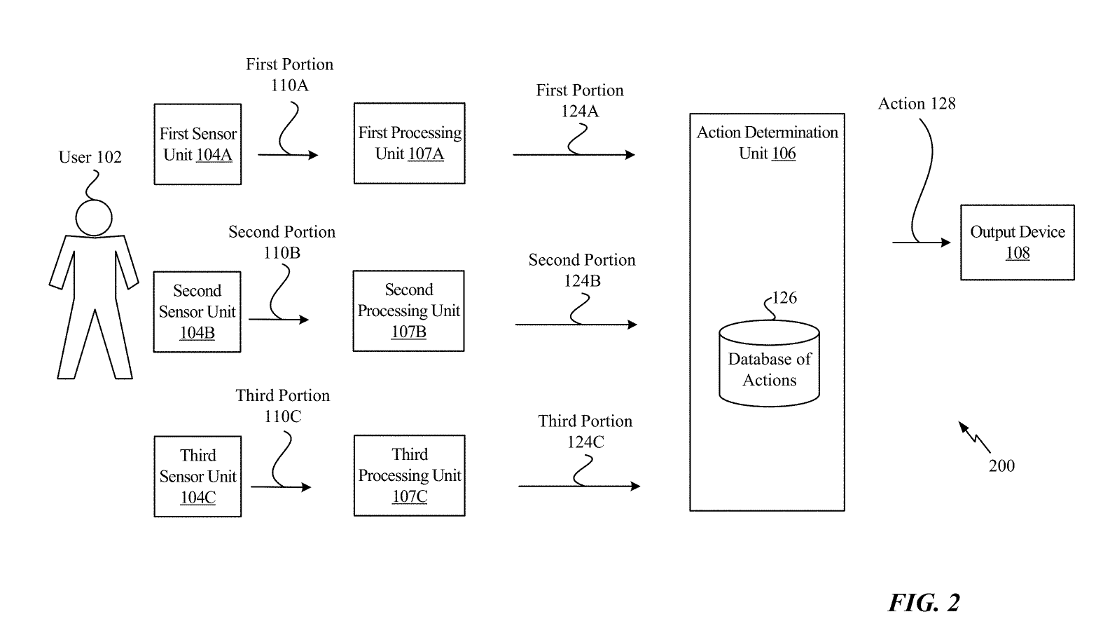

Referring to FIG. 2, another system 200 that is operable to perform an action based on sensor analysis is shown. The system 200 includes a first sensor unit 104A, a second sensor unit 104B, a third sensor unit 104C, a first processing unit 107A, a second processing unit 107B, a third processing unit 107C, and the action determination unit 106. According to one implementation, each of the sensor units 104A-104C are included in the one or more sensor units 104 of FIG. 1. According to one implementation, the processing units 107A-107C are included in the processing unit 107 of FIG. 1. According to one implementation, each processing unit 107A-107C has a similar configuration as the processing unit 107 of FIG. 1, and each processing unit 107A-107C operates in a substantially similar manner as the processing unit 107.

The first sensor unit 104A may be configured to detect a first portion 110A of the non-audible sensor data 110 associated with the user 102. As a non-limiting example, the first sensor unit 104A may detect the heart rate data. The second sensor unit 104B may be configured to detect a second portion 110B of the non-audible sensor data 110 associated with the user 102. As a non-limiting example, the second sensor unit 104B may detect electroencephalogram data. The third sensor unit 104C may be configured to detect a third portion 110C of the non-audible sensor data 110 associated with the user 102. As a non-limiting example, the third sensor unit 104C may detect electromyogram data.

Although three sensor units 104A-104C are shown, in other implementations, the system 200 may include additional sensors to detect other non-audible sensor data (e.g., skin conductance data, oxygen level data, glucose level data, etc.). According to one implementation, the system 200 may include an acceleration sensor unit configured to measure acceleration associated with the user 102. For example, the acceleration sensor unit may be configured to detect a rate at which the speed of the user 102 changes. According to one implementation, the system 200 may include a pressure sensor unit configured to measure pressure associated with an environment of the user 102.

The first processing unit 107A is configured to generate a first portion 124A of the descriptive text-based input 124 based on the first portion 110A of the non-audible sensor data 110. For example, the first portion 124A of the descriptive text-based input 124 may indicate that the user 102 is nervous because the heart rate of the user 102 is within the second range, as described with respect to FIG. 1. The second processing unit 107B is configured to generate a second portion 124B of the descriptive text-based input 124 based on the second portion 110B of the non-audible sensor data 110. For example, the second portion 124B of the descriptive text-based input 124 may indicate that the user 102 is confused because the electroencephalogram data indicates that there is a lot of electrical activity in the brain of the user 102. The third processing unit 107C is configured to generate a third portion 124C of the descriptive text-based input 124 based on the third portion 110C of the non-audible sensor data 110. For example, the third portion 124C of the descriptive text-based input may indicate that the user 102 is anxious because the electromyogram data indicates that there is a lot of electrical activity in the muscles of the user 102.

Each portion 124A-124C of the descriptive text-based input 124 is provided to the action determination unit 106. The action determination unit 106 is configured to determine the action 128 to be performed based on each portion 124A-124C of the descriptive text-based input 124. For example, the action determination unit 106 maps the first portion 124A (e.g., a text phrase for “nervous”), the second portion 124B (e.g., a text phrase for “confused”), and the third portion 124C (e.g., a text phrase for “anxious”) to the action 128 in the database of actions 126. According to the above example, the action 128 to be performed may include asking the user 102 whether he/she wants to alert paramedics. The output device 108 is configured to perform the action 128.

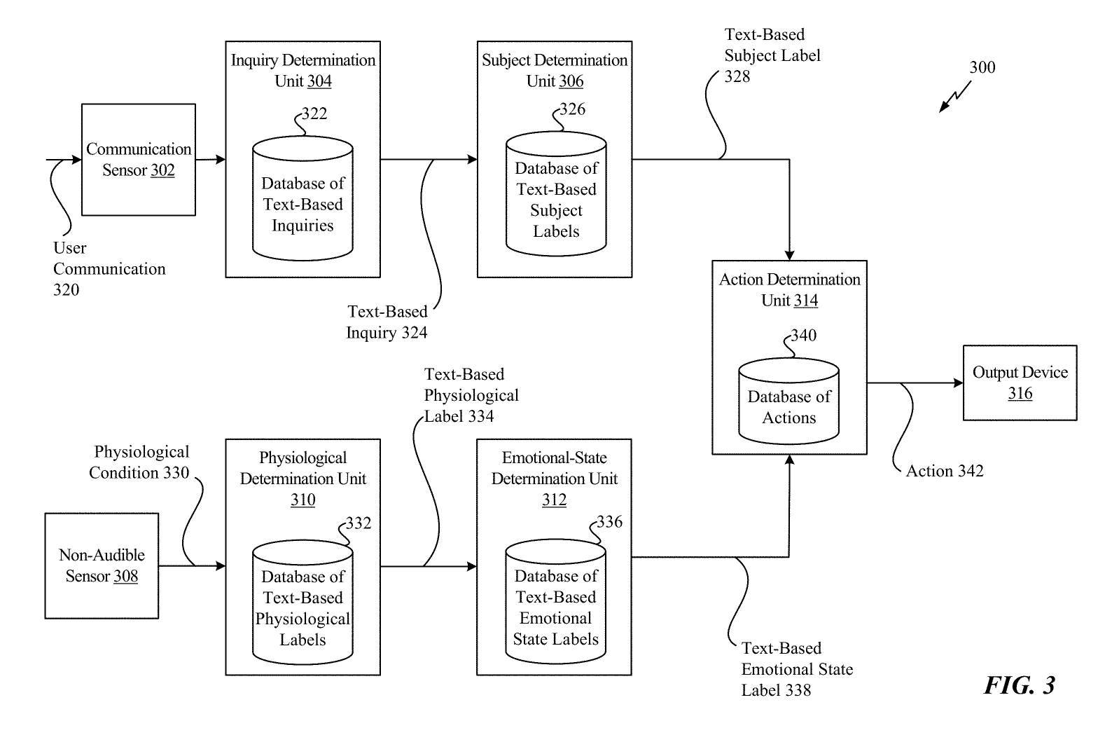

Referring to FIG. 3, a system 300 that is operable to perform an action based on multi-sensor analysis is shown. The system 300 includes a communication sensor 302, an inquiry determination unit 304, a subject determination unit 306, a non-audible sensor 308, a physiological determination unit 310, an emotional-state determination unit 312, an action determination unit 314, and an output device 316. The system 300 may be integrated into a wearable device (e.g., a smart watch). The non-audible sensor 308 may be integrated into the one or more sensor units 104 of FIG. 1. The action determination unit 314 may correspond to the action determination unit 106 of FIG. 1.

The communication sensor 302 is configured to detect user communication 320 from the user 102. The user communication 320 may be detected from verbal communication, non-verbal communication, or both. As a non-limiting example of verbal communication, the communication sensor 302 may include a microphone, and the user communication 320 may include audio captured by the microphone that states “Where am I now?” As a non-limiting example of non-verbal communication, the communication sensor 302 may include a voluntary muscle twitch monitor (or a tapping monitor), and the user communication 320 may include information indicating voluntary muscle twitches (or tapping) that indicates a desire to know a location. For example, a particular muscle twitch pattern may be programmed into the communication sensor 302 as non-verbal communication associated with a desire to know a location. An indication of the user communication 320 is provided to the inquiry determination unit 304.

The inquiry determination unit 304 is configured to determine a text-based inquiry 324 (e.g., a text-based input) based on the user communication 320. For example, the inquiry determination unit 304 includes a database of text-based inquiries 322. The inquiry determination unit 304 maps the user communication 320 to the text-based inquiry 324 in the database of text-based inquiries 322. According to the above example, the text-based inquiry 324 may include a text label that reads “Where am I now?” The text-based inquiry 324 is provided to the subject determination unit 306.

The subject determination unit 306 is configured to determine a text-based subject label 328 based on the text-based inquiry 324. For example, the subject determination unit 306 includes a database of text-based subject labels 326. The subject determination unit 306 maps the text-based inquiry 324 to the text-based subject label 328 in the database of text-based subject labels 326. According to the above example, the text-based subject label 328 may include a text label that reads “User Location”. The text-based subject label 328 is provided to the action determination unit 314.

The non-audible sensor 308 is configured to determine a physiological condition 330 of the user 102. As non-limiting examples, the non-audible sensor 308 may include an electroencephalogram (EEG) configured to detect electrical activity of the user's brain, a skin conductance/temperature monitor configured to detect an electrodermal response, a heart rate monitor configured to detect a heartrate, etc. The physiological condition 330 may include the electrical activity of the user's brain, the electrodermal response, the heartrate, or a combination thereof. The physiological condition 330 is provided to the physiological determination unit 310.

The physiological determination unit 310 is configured to determine a text-based physiological label 334 indicating the physiological condition 330 of the user. For example, the physiological determination unit 310 includes a database of text-based physiological labels 332. The physiological determination unit 310 maps the physiological condition 330 to the text-based physiological label 334 in the database of text-based physiological labels 332. To illustrate, if the physiological determination unit 310 maps the electrical activity of the user's brain to a “gamma state” text label in the database 332, the physiological determination unit 310 maps the electrodermal response to a “high” text label in the database 332, and the physiological determination unit 310 maps the heartrate to an “accelerated heartrate” in the database 332, the text-based physiological label 334 may include the phrases “gamma state”, “high”, and “accelerated heartrate”. The text-based physiological label 334 is provided to the emotional-state determination unit 312.

The emotional-state determination unit 312 is configured to determine a text-based emotional state label 338 indicating an emotional state of the user. For example, the emotional-state determination unit 312 includes a database of text-based emotional state labels 336. According to one implementation, the text-based emotional state label 338 may correspond to the descriptive text-based input 124 of FIG. 1. The emotional-state determination unit 312 maps the text-based physiological label 334 to the text-based emotional state label 338 in the database of text-based emotional state labels 336. According to the above example, the text-based emotional state label 338 may include a text label that reads “Nervous”, “Anxious”, or both. The text-based emotional state label 338 is provided to the action determination unit 314.

The action determination unit 314 is configured to determine an action 342 to be performed based on the text-based subject label 328 and the text-based emotional state label 338. For example, the action determination unit 314 includes a database of actions 340. The action determination unit 314 maps the text-based subject label 328 (e.g., “User Location”) and the text-based emotional state label 338 (e.g., “Nervous” and “Anxious”) to the action 342 in the database of actions 340. According to the above example, the action 342 to be performed may include asking the user whether he/she is okay, telling the user that he/she is in a safe environment, accessing a global positioning system (GPS) and reporting the user's location, etc. The determination of the action 342 is provided to the output device 316, and the output device 316 is configured to perform the action 342.

Thus, the system 300 enables physiological and emotional states of the user to be considered in determining an action to be performed by a wearable device.

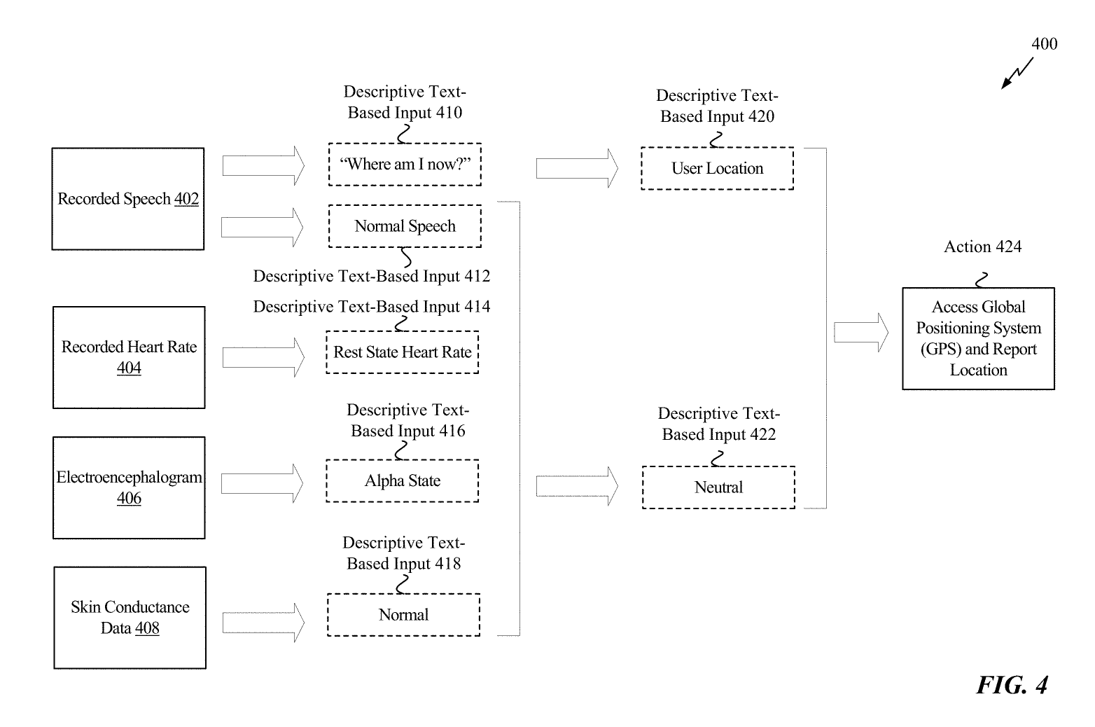

Referring to FIG. 4, a process diagram 400 for performing an action based on multi-sensor analysis is shown. According to the process diagram 400, recorded speech 402 is captured, a recorded heart rate 404 is obtained, an electroencephalogram 406 is obtained, and skin conductance data 408 is obtained. The recorded speech 402, the recorded heart rate 404, the electroencephalogram 406, and the skin conductance data 408 may be obtained using the one or more sensor units 104 of FIG. 1, the sensor units 104A-104C of FIG. 2, the communication sensor 302 of FIG. 3, the non-audible sensor 308 of FIG. 3, or a combination thereof.

A mapping operation is performed on the recorded speech 402 to generate a descriptive text-based input 410 that is indicative of the recorded speech 402. For example, the user 102 may speak the phrase “Where am I now?” into a microphone as the recorded speech 402, and the processor 105 may map the spoken phrase to corresponding text as the descriptive text-based input 410. As described herein, a “mapping operation” includes mapping data (or text phrases) to textual phrases or words as a descriptive text-based label (input). The mapping operations are illustrated using arrows and may be performed using the one or more trained mapping models 114 and the library of descriptive text-based inputs 116. Additionally, the processor 105 may map the tone of the user 102 as a descriptive text-based input 412. For example, the processor 105 may determine that the user 102 spoke the phase “Where am I now?” using a normal speech tone and may map speech tone to the phrase “Normal Speech” as the descriptive text-based input 412.

The recorded heart rate 404 may correspond to a resting heart rate, and the processor 105 may map the recorded heart rate 404 to the phrase “Rest State Heart Rate” as a descriptive text-based input 414. The electroencephalogram 406 may yield results that the brain activity of the user 102 has an alpha state, and the processor 105 may map the electroencephalogram 406 to the phrase “Alpha State” as a descriptive text-based input 416. The skin conductance data 408 may yield results that the skin conductance of the user 102 is normal, and the processor 105 may map the skin conductance data 408 to the phrase “Normal” as a descriptive text-based input 418.

The descriptive text-based input 410 may be mapped to intent. For example, a processor (e.g., the subject determination unit 306 of FIG. 3) may map the descriptive text-based input 410 (e.g., the phrase “Where am I now?”) to the phrase “user location” as a descriptive text-based input 420. Thus, the intent of the user 102 is to determine the user location. The descriptive text-based inputs 412-418 may be mapped to a user status. For example, a processor (e.g., the emotional-state determination unit 312 of FIG. 3) may map the phrases “normal speech”, “rest state heart rate”, “alpha state” and “normal” to the phrase “neutral” as a descriptive text-based input 422. Thus, the user status (e.g., emotional state) of the user 102 is neutral. Based on the intent and the user status, the action determination unit 106 may determine an action 424 to be performed. According to the described scenario, the action 424 to be performed is accessing a global positioning system (GPS) and reporting the user location to the user 102.

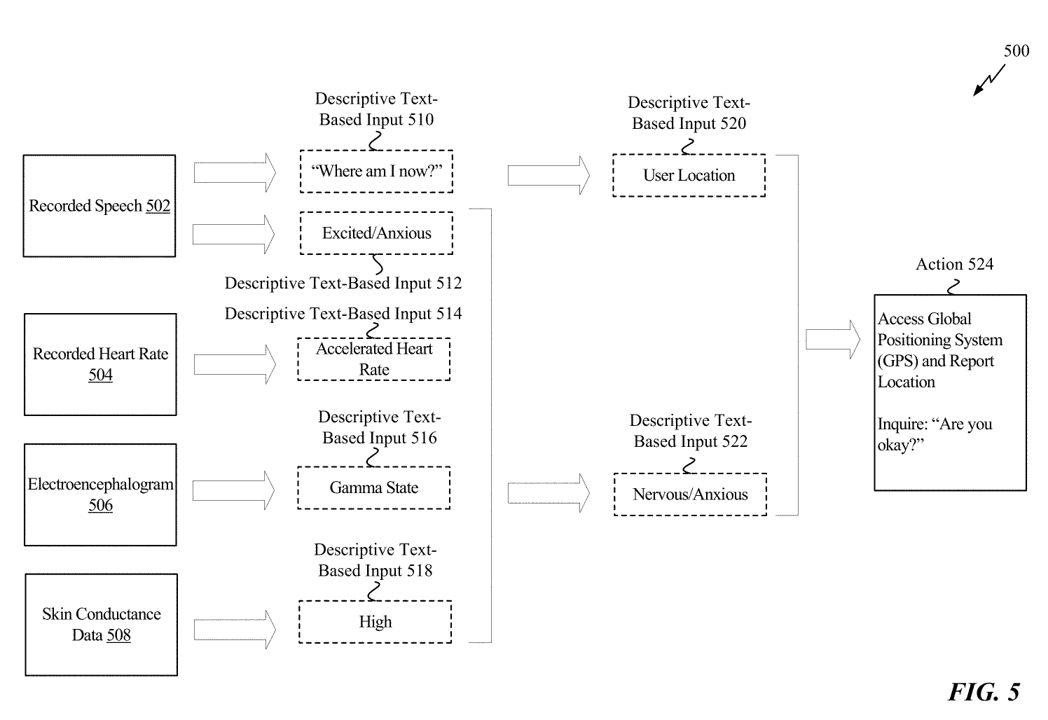

Referring to FIG. 5, another process diagram 500 for performing an action based on multi-sensor analysis is shown. According to the process diagram 500, recorded speech 502 is captured, a recorded heart rate 504 is obtained, an electroencephalogram 506 is obtained, and skin conductance data 508 is obtained. The recorded speech 502, the recorded heart rate 504, the electroencephalogram 506, and the skin conductance data 508 may be obtained using the one or more sensor units 104 of FIG. 1, the sensor units 104A-104C of FIG. 2, the communication sensor 302 of FIG. 3, the non-audible sensor 308 of FIG. 3, or a combination thereof.

A mapping operation is performed on the recorded speech 502 to generate a descriptive text-based input 510 that is indicative of the recorded speech 502. The recorded speech 502 corresponds to audible sensor data associated with the user 102. For example, the user 102 may speak the phrase “Where am I now?” into a microphone as the recorded speech 502, and the processor 105 may map the spoken phrase to corresponding text as the descriptive text-based input 510. Additionally, the processor 105 may map the tone of the user 102 to a descriptive text-based input 512. For example, the processor 105 may determine that the user 102 spoke the phase “Where am I now?” using an excited or anxious tone and may map speech tone to the phrase “Excited/Anxious” as the descriptive text-based input 512.

The recorded heart rate 504 may correspond to an accelerated heart rate, and the processor 105 may map the recorded heart rate 504 to the phrase “Accelerated Heart Rate” as a descriptive text-based input 514. The electroencephalogram 506 may yield results that the brain activity of the user 102 has a gamma state, and the processor 105 may map the electroencephalogram 506 to the phrase “Gamma State” as a descriptive text-based input 516. The skin conductance data 508 may yield results that the skin conductance of the user 102 is high, and the processor 105 may map the skin conductance data 508 to the phrase “High” as a descriptive text-based input 518.

The descriptive text-based input 510 may be mapped to intent. For example, a processor may map the descriptive text-based input 510 (e.g., the phrase “Where am I now?”) to the phrase “user location” as a descriptive text-based input 520. Thus, the intent of the user 102 is to determine the user location. The descriptive text-based inputs 512-518 may be mapped to a user status. For example, the processor may map the phrases “Excited/Anxious”, “Accelerated Heart Rate”, “Gamma State” and “High” to the phrase “Nervous/Anxious” as a descriptive text-based input 522. Thus, the user status of the user 102 is nervous and anxious. Based on the intent and the user status, the action determination unit 106 may determine an action 524 to be performed. According to the described scenario, the action 524 to be performed is accessing a global positioning system (GPS), reporting the user location to the user 102, and inquiring whether the user 102 is okay.

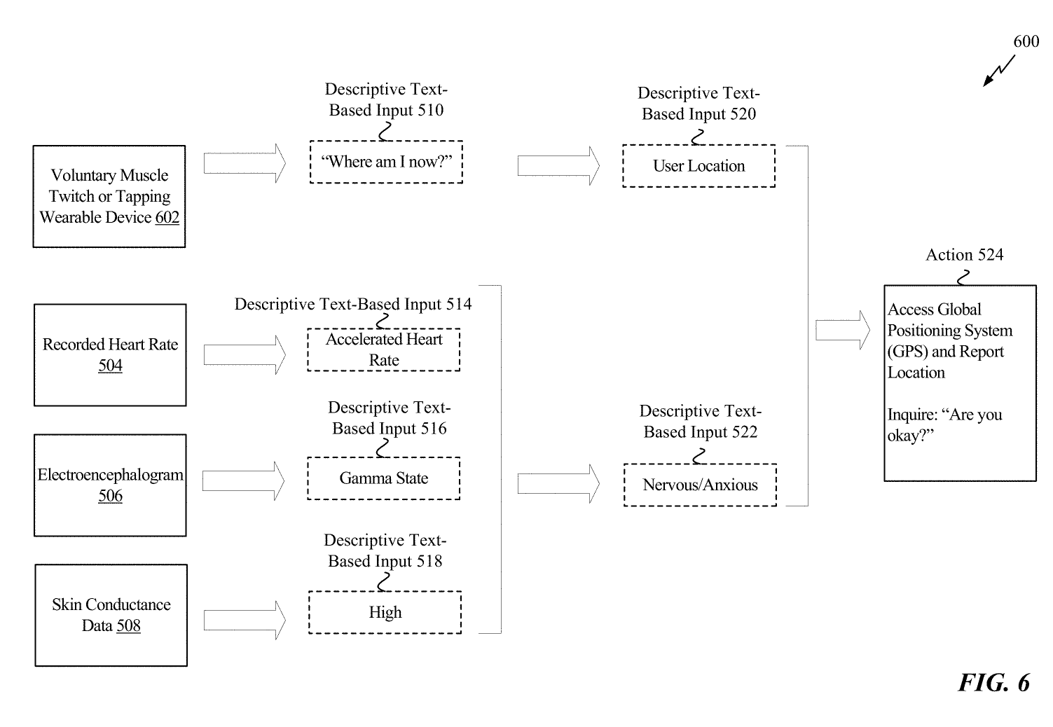

Referring to FIG. 6, another process diagram 600 for performing an action based on multi-sensor analysis is shown. The operations in the process diagram 600 are similar to the operations in the process diagram 500 of FIG. 5, however, the process diagram 600 maps a voluntary muscle twitch or a tap of the wearable device 602 map to the descriptive text-based input 510. Thus, non-verbal cues (e.g., muscle twitching or tapping) may be used as communication.

Thus, if the user 102 is unable to user their voice in certain situations, non-verbal cues (e.g., tapping, muscle movements, etc.) for pre-defined or configurable actions may be used. In addition, user needs may be determined by monitoring physiological states and checking habits to initiate services after cross-checking with the user 102.

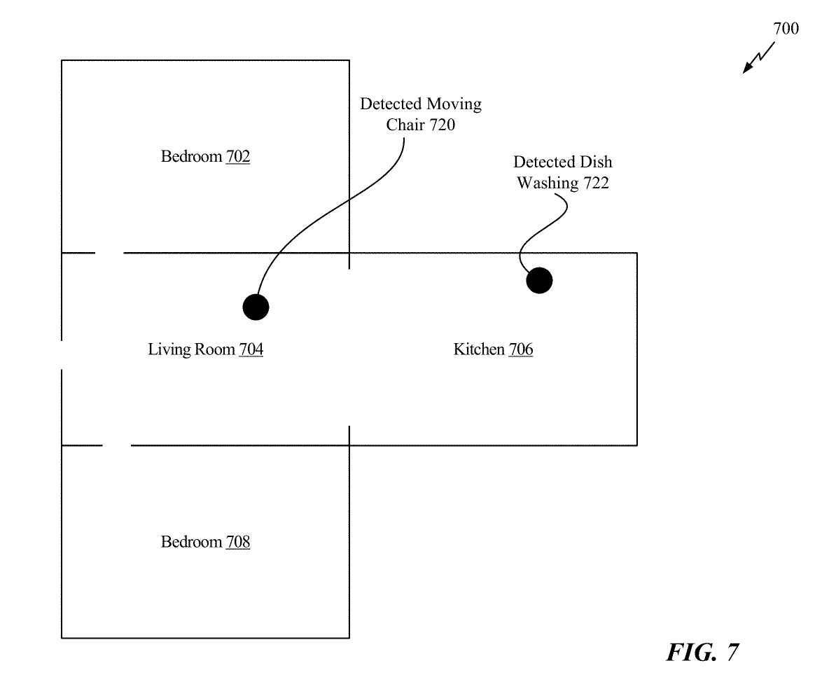

Referring to FIG. 7, a portion of a home 700 is shown. The home 700 includes a bedroom 702, a living room 704, a kitchen 706, and a bedroom 708. The one or more sensor units 104 may detect activity in different rooms 702-708 of the home 700. For example, the one or more sensor units 104 may detect 720 a chair moving in the living room and may detect 722 dish washing in the kitchen. Based on the detected events 720, 722, actions may be adjusted. For example, in response to detecting 720 the chair move, the action determination unit 106 may inquire whether the user 102 is aware that somebody is leaving the living room 704, tell the user 102 where the coats of the guests are stored, etc. Thus, based on the detected events, smart assistant services may anticipate a user's need.

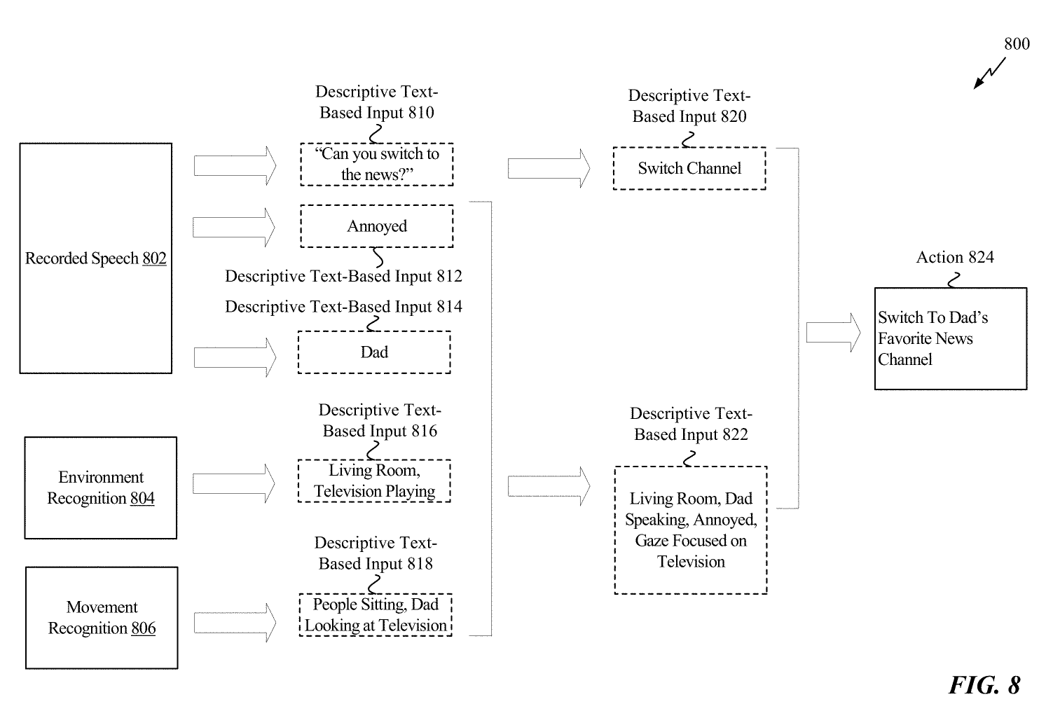

Referring to FIG. 8, a process diagram 800 for performing an action based on multi-sensor analysis is shown. According to the process diagram 800, recorded speech 802 is captured, environment recognition 804 is performed, and movement recognition 806 is performed. The speech recording process 802, the environment recognition 804, and the movement recognition 806 may be performed using the one or more sensor units 104 of FIG. 1, the sensor units 104A-104C of FIG. 2, the communication sensor 302 of FIG. 3, the non-audible sensor 308 of FIG. 3, or a combination thereof.

A mapping operation is performed on the recorded speech 802 to generate a descriptive text-based input 810 that is indicative of the recorded speech 802. For example, the recorded speech 802 may include the phrase “Can you switch to the news?”, and the phrase may be mapped to the descriptive text-based input 810. A mapping operation may also be performed on the recorded speech 802 to generate a descriptive text-based input 812 that is indicative of a tone of the recorded speech 802. For example, the phrase “Can you switch to the news?” may be spoken in an annoyed tone of voice, and the phrase “annoyed” may be mapped to a descriptive text-based input 812. Additionally, a mapping operation may be performed on the recorded speech 802 to generate a descriptive text-based input 810 that identifies the speaker. For example, the phrase “Can you switch to the news?” may be spoken by the dad, and the phrase “Dad” may be mapped to the descriptive text-based input 814.

The processor 105 may perform the environmental recognition 804 to determine the environment. The processor 105 may determine that the environment is a living room (e.g., the living room 704 of FIG. 4) and that a television is playing in the living room. The processor 105 may map the environment recognition 804 operation to the phrase “Living Room, Television Playing” as a descriptive text-based input 816. The one or more sensor units 104 may perform the movement recognition 806 to detect movement with the living room. For example, the one or more sensor units 104 may detect that people are sitting and the dad is looking at the television. Based on the detection, the processor 105 may map the movement recognition 806 operation to the phrase “People Sitting, Dad Looking at Television” as a descriptive text-based input 818.

The descriptive text-based input 810 may be mapped to intent. For example, a processor may map the descriptive text-based input 810 (e.g., the phrase “Can you switch to the news?”) to the phrase “Switch Channel” as a descriptive text-based input 820. Thus, the intent is to switch the television channel. The descriptive text-based inputs 812-818 may be mapped to a single descriptive text-based input 822. For example, the descriptive text-based input 822 may include the phrases “Living Room, Dad Speaking, Annoyed, Gaze Focused on Television.” Based on the descriptive text-based inputs 820, 822, the action determination unit 106 may determine an action 824 to be performed. According to the described scenario, the action 824 to be performed is switching the television to the dad's favorite news channel.

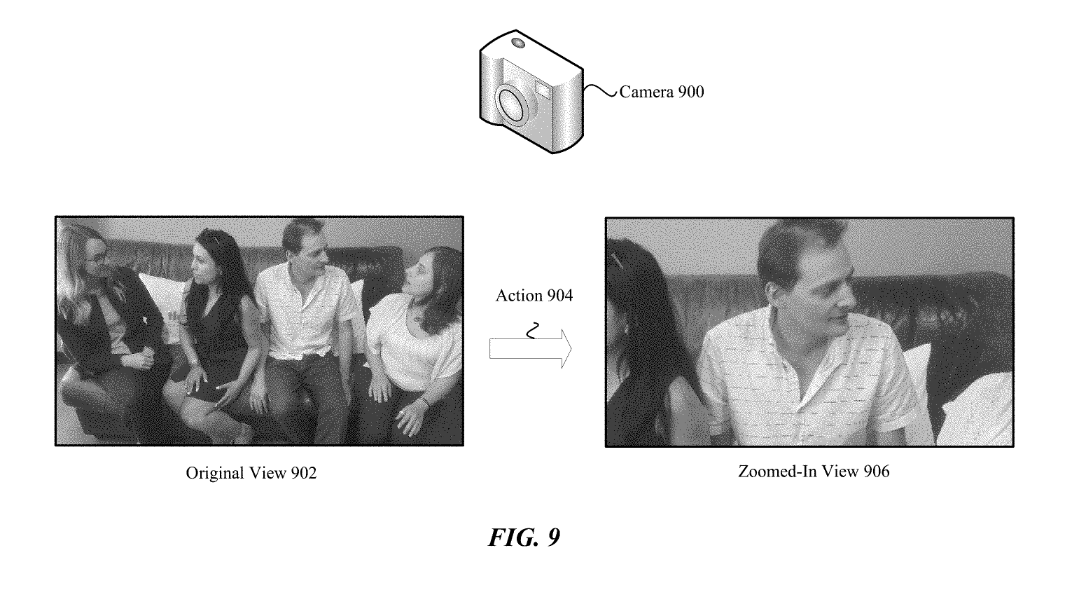

Referring to FIG. 9, an example of performing an action according to the techniques described above using a camera is shown. For example, a camera 900 may capture a scene based on an original view 902. According to some implementations, the camera 900 is integrated into the system 100 of FIG. 1. For example, the camera 900 may be integrated into the output device 108 of FIG. 1. The action determination unit 106 may map descriptive text-based inputs to an action 904 that includes zooming into the scene. As a result, the camera 900 may perform a zoom operation and capture the scene based on a zoom-in view 906.

Thus, the techniques described with respect to FIGS. 1-9 enable systems to determine, by using natural language processing (NLP), a user's emotional engagement level (e.g., level of frustration, nervousness, etc.), physiological cues, environmental cues, or a combination thereof. The descriptive text-based inputs may be concatenated at a NLP unit (e.g., the action determination unit 106), and the NLP unit may determine the action to be performed based on the concatenated descriptive text-based inputs. For example, the descriptive text-based inputs may be provided as inputs to the NLP unit. NLP may enable performance of more accurate actions and may result in appropriate inquires based on the physiological cues and the environmental cues.

The methodology for designing the mapping operation for sensory data to text mapping includes collecting input sensor data with associated state text labels. The methodology further includes dividing a dataset into a training set and a verification set and defining a mapping model architecture. The methodology further includes training the model by reducing classification errors on the training set while monitoring the classification error on the verification set. The methodology further includes using the training and verification set classification set error evolution at each iteration to determine whether training is to be adjusted or stopped to reduce under-fitting and overfitting.

The methodology for designing the mapping operation for text labels grouped into sentences to later stages (e.g., intent stages, action stages, user status mapping stages, etc.) includes collecting sentences (composed of various sensor data transcriptions) associated with the text labels. The methodology further includes dividing a dataset into a training set and a verification set and defining a mapping model architecture. The methodology further includes training the model by reducing classification errors on the training set while monitoring the classification error on the verification set. The methodology further includes using the training and verification set classification set error evolution at each iteration to determine whether training is to be adjusted or stopped to reduce under-fitting and overfitting.

The methodology for designing the mapping operation for user statuses and intent to system response mapping stages includes collecting sentences associated with system response labels. The methodology further includes dividing a dataset into a training set and a verification set and defining a mapping model architecture. The methodology further includes training the model by reducing classification errors on the training set while monitoring the classification error on the verification set. The methodology further includes using the training and verification set classification set error evolution at each iteration to determine whether training is to be adjusted or stopped to reduce under-fitting and overfitting.

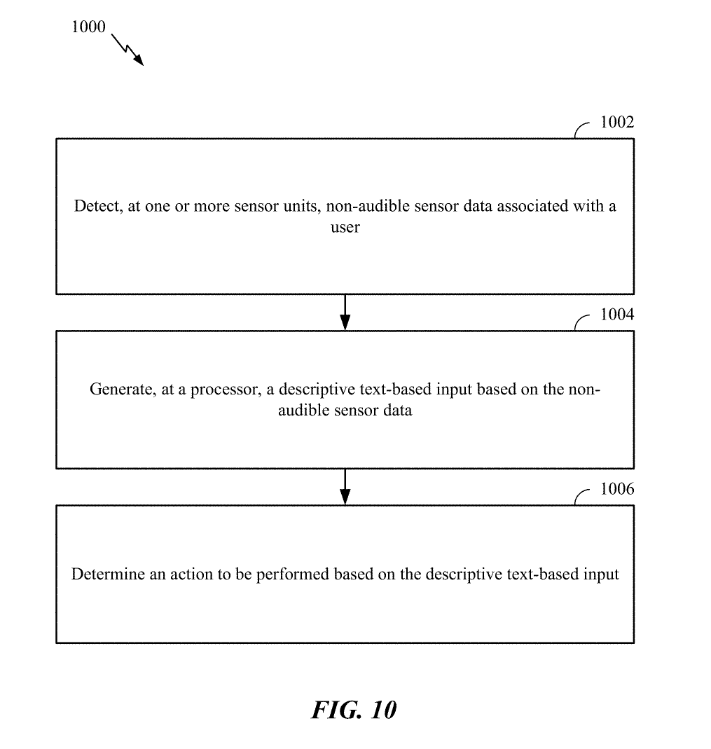

Referring to FIG. 10, a method 1000 for performing an action based on sensor analysis is shown. The method 1000 may be performed by the one or more sensor unit 104 of FIG. 1, the action determination unit 106 of FIG. 1, the output device 108 of FIG. 1, the sensor units 104A-104C, the communication sensor 302 of FIG. 3, the inquiry determination unit 304 of FIG. 3, the subject determination unit 306 of FIG. 3, the non-audible sensor 308 of FIG. 3, the physiological determination unit 310 of FIG. 3, the emotional-state determination unit 312 of FIG. 3, the action determination unit 314 of FIG. 3, the output device 316 of FIG. 3, the camera 900 of FIG. 9, or a combination thereof.

The method 1000 includes detecting, at one or more sensor units, non-audible sensor data associated with a user, at 1002. For example, referring to FIG. 1, the one or more sensor units 104 are configured to detect the non-audible sensor data 110 associated with the user 102. The non-audible sensor data 110 may be physiological data (associated with the user 102) that is detected by the one or more sensor units 104. The physiological data may include at least one of electroencephalogram data, electromyogram data, heart rate data, skin conductance data, oxygen level data, glucose level data, etc.

The method 1000 also includes generating a descriptive text-based input based on the non-audible sensor data, at 1004. For example, referring to FIG. 1, the processor 105 may generate the descriptive text-based input 124 based on the non-audible sensor data 110.

The method 1000 also includes determining an action to be performed based on the descriptive text-based input, at 1006. For example, referring to FIG. 1, the action determination unit 106 may determine the action 128 to be performed based on the descriptive text-based input 124. The action determination unit 106 maps the descriptive text-based input 124 (e.g., “nervous”) to the action 128 in the database of actions 126. According to the above example, the action 128 to be performed may include asking the user 102 whether he/she is okay.

Thus, the method 1000 enables physiological states of the user 102 to be considered in determining an action to be performed by a wearable device.

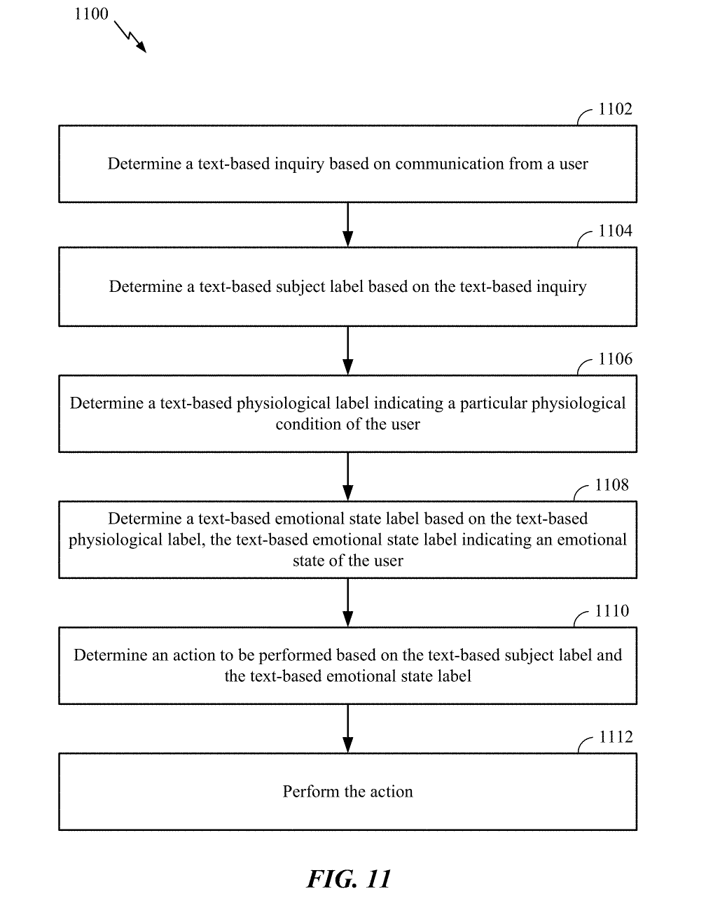

Referring to FIG. 11, a method 1100 for performing an action based on sensor analysis is shown. The method 1100 may be performed by the one or more sensor unit 104 of FIG. 1, the action determination unit 106 of FIG. 1, the output device 108 of FIG. 1, the sensor units 104A-104C, the communication sensor 302 of FIG. 3, the inquiry determination unit 304 of FIG. 3, the subject determination unit 306 of FIG. 3, the non-audible sensor 308 of FIG. 3, the physiological determination unit 310 of FIG. 3, the emotional-state determination unit 312 of FIG. 3, the action determination unit 314 of FIG. 3, the output device 316 of FIG. 3, the camera 900 of FIG. 9, or a combination thereof.

The method 1100 includes determining a text-based inquiry based on communication from a user, at 1102. For example, referring to FIG. 3, the inquiry determination unit 304 determines the text-based inquiry 324 (e.g., a text-based input) based on the user communication 320. For example, the inquiry determination unit 304 includes a database of text-based inquiries 322. The inquiry determination unit 304 maps the user communication 320 to the text-based inquiry 324 in the database of text-based inquiries 322.

The method 1100 also includes determining a text-based subject label based on the text-based inquiry, at 1104. For example, referring to FIG. 3, the subject determination unit 306 determines the text-based subject label 328 based on the text-based inquiry 324. The subject determination unit 306 maps the text-based inquiry 324 to the text-based subject label 328 in the database of text-based subject labels 326.

The method 1100 also includes determining a text-based physiological label indicating a particular physiological condition of the user, at 1106. For example, referring to FIG. 3, the physiological determination unit 310 determines the text-based physiological label 334 indicating the physiological condition 330 of the user. The physiological determination unit 310 maps the physiological condition 330 to the text-based physiological label 334 in the database of text-based physiological labels 332.

The method 1100 also includes determining a text-based emotional state label based on the text-based physiological label, at 1108. The text-based emotional state label indicates an emotional state of the user. For example, referring to FIG. 3, the emotional-state determination unit 312 determines the text-based emotional state label 338 indicating an emotional state of the user. The emotional-state determination unit 312 maps the text-based physiological label 334 to the text-based emotional state label 338 in the database of text-based emotional state labels 336.

The method 1100 also includes determining an action to be performed based on the text-based subject label and the text-based emotional state label, at 1110. For example, referring to FIG. 3, the action determination unit 314 determines the action 342 to be performed based on the text-based subject label 328 and the text-based emotional state label 338. The action determination unit 314 maps the text-based subject label 328 and the text-based emotional state label 338 to the action 342 in the database of actions 340. The method 1100 also includes performing the action, at 1112. For example, referring to FIG. 3, the output device 316 performs the action 342.

Thus, the method 1100 enables physiological and emotional states of the user to be considered in determining an action to be performed by a wearable device.

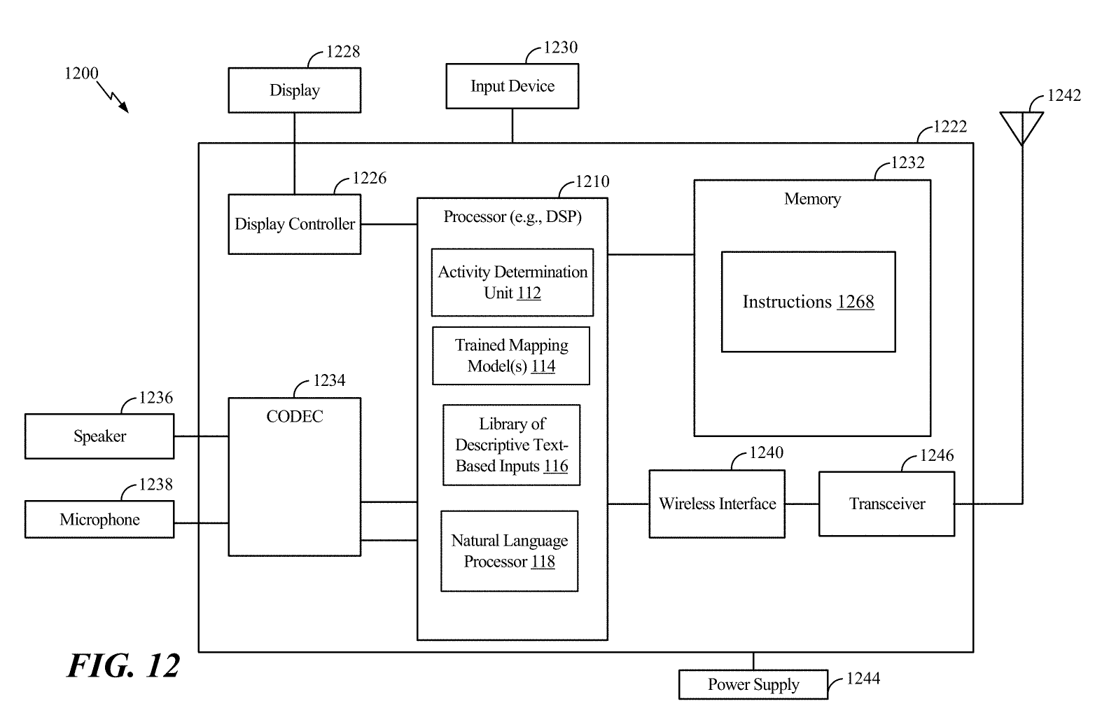

Referring to FIG. 12, a block diagram of a particular illustrative implementation of a device (e.g., a wireless communication device) is depicted and generally designated 1200. In various implementations, the device 1200 may have more components or fewer components than illustrated in FIG. 12. In a particular implementation, the device 1200 includes a processor 1210, such as a central processing unit (CPU) or a digital signal processor (DSP), coupled to a memory 1232. The processor 1210 includes the activity determination unit 112, the one or more trained mapping models 114, the library of descriptive text-based inputs 116, and the natural language processor 118. Thus, components 112-118 may be integrated into a central processor (e.g., the processor 1210) as opposed to being integrated into a plurality of different sensors.

The memory 1232 includes instructions 1268 (e.g., executable instructions) such as computer-readable instructions or processor-readable instructions. The instructions 1268 may include one or more instructions that are executable by a computer, such as the processor 1210.

FIG. 12 also illustrates a display controller 1226 that is coupled to the processor 1210 and to a display 1228. A coder/decoder (CODEC) 1234 may also be coupled to the processor 1210. According to some implementations, at least one of the activity determination unit 112, the one or more trained mapping models 114, the library of descriptive text-based inputs 116, or the natural language processor 118 is included in the CODEC 1234. A speaker 1236 and a microphone 1238 are coupled to the CODEC 1234.

FIG. 12 further illustrates that a wireless interface 1240, such as a wireless controller, and a transceiver 1246 may be coupled to the processor 1210 and to an antenna 1242, such that wireless data received via the antenna 1242, the transceiver 1246, and the wireless interface 1240 may be provided to the processor 1210. In some implementations, the processor 1210, the display controller 1226, the memory 1232, the CODEC 1234, the wireless interface 1240, and the transceiver 1246 are included in a system-in-package or system-on-chip device 1222. In some implementations, an input device 1230 and a power supply 1244 are coupled to the system-on-chip device 1222. Moreover, in a particular implementation, as illustrated in FIG. 12, the display 1228, the input device 1230, the speaker 1236, the microphone 1238, the antenna 1242, and the power supply 1244 are external to the system-on-chip device 1222. In a particular implementation, each of the display 1228, the input device 1230, the speaker 1236, the microphone 1238, the antenna 1242, and the power supply 1244 may be coupled to a component of the system-on-chip device 1222, such as an interface or a controller.

The device 1200 may include a headset, a smart watch, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a component of a vehicle, or any combination thereof, as illustrative, non-limiting examples.

In an illustrative implementation, the memory 1232 may include or correspond to a non-transitory computer readable medium storing the instructions 1268. The instructions 1268 may include one or more instructions that are executable by a computer, such as the processor 1210. The instructions 1268 may cause the processor 1210 to perform the method 1000 of FIG. 10, the method 1100 of FIG. 11, or both.

One or more components of the device 1200 may be implemented via dedicated hardware (e.g., circuitry), by a processor executing instructions to perform one or more tasks, or a combination thereof. As an example, the memory 1232 or one or more components of the processor 1210, and/or the CODEC 1234 may be a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include instructions (e.g., the instructions 1268) that, when executed by a computer (e.g., a processor in the CODEC 1234 or the processor 1210), may cause the computer to perform one or more operations described with reference to FIGS. 1-11.

In a particular implementation, one or more components of the systems and devices disclosed herein may be integrated into a decoding system or apparatus (e.g., an electronic device, a CODEC, or a processor therein), into an encoding system or apparatus, or both. In other implementations, one or more components of the systems and devices disclosed herein may be integrated into a wireless telephone, a tablet computer, a desktop computer, a laptop computer, a set top box, a music player, a video player, an entertainment unit, a television, a game console, a navigation device, a communication device, a personal digital assistant (PDA), a fixed location data unit, a personal media player, or another type of device.

In conjunction with the described techniques, an apparatus includes means for detecting non-audible sensor data associated with a user. For example, the means for detecting may include the one or more sensor units 104 of FIG. 1, the sensor units 104A-104C of FIG. 2, the communication sensor 302 of FIG. 3, the non-audible sensor 308 of FIG. 3, the microphone 1238 of FIG. 12, one or more other devices, circuits, modules, sensors, or any combination thereof.

The apparatus also includes means for generating a descriptive text-based input based on the non-audible sensor data. For example, the means for generating may include the processing unit 107 of FIG. 1, the processing units 107A-107C of FIG. 2, the inquiry determination unit 304 of FIG. 3, the subject determination unit 306 of FIG. 3, the physiological determination unit 310 of FIG. 3, the emotional-state determination unit 312 of FIG. 3, the processor 1210 of FIG. 12, one or more other devices, circuits, modules, or any combination thereof.

The apparatus also includes means for determining an action to be performed based on the descriptive text-based input. For example, the means for determining may include the action determination unit 106 of FIG. 1, the action determination unit 314 of FIG. 3, the processor 1210 of FIG. 12, one or more other devices, circuits, modules, or any combination thereof.

Those of skill would further appreciate that the various illustrative logical blocks, configurations, modules, circuits, and algorithm steps described in connection with the implementations disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. An apparatus comprising:
one or more sensor units configured to detect non-audible sensor data associated with a user; and
a processor, including an action determination unit, coupled to the one or more sensor units, the processor configured to:
generate a descriptive text-based input based on the non-audible sensor data; and
determine an action to be performed based on the descriptive text-based input.

2. The apparatus of claim 1, wherein the descriptive text-based input is configurable.

3. The apparatus of claim 1, wherein a first range of the non-audible sensor data is indicative of the descriptive text-based input if the user is engaged in a first activity.

4. The apparatus of claim 3, wherein the first range of the non-audible sensor data is indicative of a different descriptive text-based input if the user is engaged in a second activity.

5. The apparatus of claim 1,
wherein the one or more sensor units comprise:
a first sensor unit configured to detect a first portion of the non-audible sensor data; and
a second sensor unit configured to detect a second portion of the non-audible sensor data, and
wherein the processor is further configured to:
generate a first portion of the descriptive text-based input based on the first portion of the non-audible sensor data; and
generate a second portion of the descriptive text-based input based on the second portion of the non-audible sensor data.

6. The apparatus of claim 1, wherein the non-audible sensor data is physiological data.

7. The apparatus of claim 6, wherein the physiological data includes at least one of electroencephalogram data, electromyogram data, heart rate data, skin conductance data, oxygen level data, or glucose level data.

8. The apparatus of claim 1, wherein at least one sensor unit of the one or more sensor units is configured to measure acceleration associated with the user.

9. The apparatus of claim 1, wherein at least one sensor unit of the one or more sensor units is configured to measure pressure associated with an environment of the user.

10. The apparatus of claim 1, wherein the one or more sensor units is integrated into one or more processors.

11. The apparatus of claim 1, further comprising a camera coupled to the processor, the camera configured to detect objects based on an eye gaze of the user.

12. The apparatus of claim 1, further comprising a library of descriptive text-based inputs that includes the descriptive text-based input.

13. The apparatus of claim 1, wherein the one or more sensor units comprise an application interface configured to interface the descriptive text-based input to the action.

14. The apparatus of claim 1, wherein the descriptive text-based input is intuitive to the user.

15. The apparatus of claim 1, wherein the descriptive text-based input is generated using a trained mapping model.

16. The apparatus of claim 1, wherein at least one sensor unit of the one or more sensor units is configured to detect audible sensor data associated with the user.

17. The apparatus of claim 1, wherein the descriptive text-based input includes one or more words that associate a contextual meaning to one or more numerical values, the one or more numerical values indicative of the non-audible sensor data.

18. A method comprising:
detecting, at one or more sensor units, non-audible sensor data associated with a user;
generating, at a processor, a descriptive text-based input based on the non-audible sensor data; and
determining an action to be performed based on the descriptive text-based input.

19. The method of claim 18, wherein the descriptive text-based input is configurable.

20. The method of claim 18, wherein a first range of the non-audible sensor data is indicative of the descriptive text-based input if the user is engaged in a first activity.

21. The method of claim 20, wherein the first range of the non-audible sensor data is indicative of a different descriptive text-based input if the user is engaged in a second activity.

22. The method of claim 18, further comprising:
detecting, at a first sensor unit, a first portion of the non-audible sensor data; and
generating, at the processor, a first portion of the descriptive text-based input based on the first portion of the non-audible sensor data;
detecting, at a second sensor unit, a second portion of the non-audible sensor data; and
generating, at the processor, a second portion of the descriptive text-based input based on the second portion of the non-audible sensor data.

23. The method of claim 18, wherein the non-audible sensor data is physiological data.

24. An apparatus comprising:
means for detecting non-audible sensor data associated with a user;
means for generating a descriptive text-based input based on the non-audible sensor data; and
means for determining an action to be performed based on the descriptive text-based input.

25. The apparatus of claim 24, wherein the descriptive text-based input is configurable.

26. The apparatus of claim 24, wherein a first range of the non-audible sensor data is indicative of the descriptive text-based input if the user is engaged in a first activity.

27. The apparatus of claim 26, wherein the first range of the non-audible sensor data is indicative of a different descriptive text-based input if the user is engaged in a second activity.

28. A non-transitory computer-readable medium comprising instructions that, when executed by a processor, cause the processor to perform operations comprising:
processing non-audible sensor data associated with a user, the non-audible sensor data detected by one or more sensor units;
generating a descriptive text-based input based on the non-audible sensor data; and
determining an action to be performed based on the descriptive text-based input.

29. The non-transitory computer-readable medium of claim 28, wherein the descriptive text-based input is intuitive to the user.

30. The non-transitory computer-readable medium of claim 28, wherein the descriptive text-based input is generated using a trained mapping model.
